(19) United States
(12) Patent Application Publication
(10) Pub. No.: US 2024/0027070 A1
(43) Pub. Date: Jan. 25, 2024

(54) NOZZLE DEVICE FOR FEEDING AT LEAST ONE GASEOUS FUEL AND ONE LIQUID FUEL, SET, SUPPLY LINE SYSTEM, AND GAS TURBINE ASSEMBLY

(71) Applicant: Rolls-Royce Deutschland Ltd & Co KG, Blankenfelde-Mahlow (DE)

(72) Inventor: Carsten CLEMEN, Mittenwalde (DE)

(21) Appl. No.: 18/353,405

(22) Filed: Jul. 17, 2023

(30) Foreign Application Priority Data
Jul. 21, 2022 (DE) 10 2022 207 492.0

(51) Int. Cl. F23R 3/36; F23D 17/00

(52) U.S. Cl. CPC F23R 3/36; F23D 17/002; F05D 2220/323; F05D 2240/35

(57) ABSTRACT

A nozzle device for feeding a gaseous fuel and a liquid fuel into a combustion chamber of a gas turbine assembly, includes: a nozzle main body having nozzle openings for injecting the gaseous and/or liquid fuels into the combustion chamber, a liquid fuel line for the fluidic connection between a liquid supply line system and the nozzle openings, and at least one gas fuel line for the fluidic connection between a gas supply line system and the nozzle openings. An optimized operation is achieved in that at least partly the gas fuel line is configured to be correlated with the liquid fuel line, wherein a flow cross section AiH2 of the gas fuel line is proportional to a flow cross section AiK of the liquid fuel line by a factor F, where: AiH2=F*Aik, F being 2.4-3, preferably 2.6-2.8, e.g. 2.7.

This application claims priority to German Patent Application 102022207492.0 filed Jul. 21, 2022, the entirety of which is incorporated by reference herein.

The invention relates to a nozzle device for feeding at least one gaseous fuel and one liquid fuel into a combustion chamber of a gas turbine assembly, in particular an engine of an aircraft, comprising a nozzle main body having nozzle openings for injecting the gaseous fuel and/or the liquid fuel into the combustion chamber, and at least one liquid fuel line for the fluidic connection between a liquid supply line system and the nozzle openings, and at least one gas fuel line for the fluidic connection between a gas supply line system and the nozzle openings. The invention furthermore relates to a set comprising at least one gas connector line and at least one liquid connector line, to a set comprising at least one gas ring line and one liquid ring line, to a supply line system, and to a gas turbine assembly.

A nozzle device of the type mentioned above is disclosed in US 2016/0 201 897 A1.

A gas turbine assembly having a supply line system of the type mentioned above is disclosed in CN 112 709 639 A.

In known gas turbine assemblies, in particular engines for aircraft, as stated above for example, fuels of different types, in particular liquid and/or gaseous fuels, can be injected in a mutually alternative manner or simultaneously into the combustion chamber by means of a nozzle device. There is the objective of further optimizing the operation of the gas turbine assembly in this respect.

The present invention is based on the object of providing a nozzle device and a supply line system and a gas turbine assembly for an optimized operation with liquid and gaseous fuels.

In terms of the nozzle device, the object is achieved by the features of claim 1. Advantageous variants of design embodiments are set forth in the dependent claims.

For achieving the object in terms of the nozzle device it is proposed that at least in portions, in at least one correlated portion, the gas fuel line is configured so as to be correlated with the liquid fuel line, wherein a flow cross section AiH2 of the gas fuel line is proportional to a flow cross section AiK of the liquid fuel line by a factor F, where:

AiH2=F*Aik, F being between 2.4 and 3, preferably between 2.6 and 2.8, e.g. 2.7.

The gas fuel line and/or the liquid fuel line serve in particular for collectively supplying the gaseous and/or liquid fuel from the gas and/or liquid supply line system to the nozzle main body, respectively, for example by way of a respective gas and/or liquid manifold assembly for distributing the respective fuel flow to the nozzle openings.

The flow diameter is in particular constant within the correlated portion. The correlation relates in particular to a portion of the gas fuel line and of the liquid fuel line which is positioned identically or in an identical manner in axial terms and/or in terms of the line profile (e.g. at the same relative position) and within which the correlated (axial) portion is formed.

It has been demonstrated that using a basic design of this type, similar flow conditions for the gaseous, in particular hydrogen-based, fuels and the liquid fuels, which have properties typical of a kerosene-based and/or kerosene-related fuel (e.g. Jet A-1, diesel fuel, or a synthetic substitute fuel (SAF—“sustainable aviation fuel”)), can advantageously be achieved at typical conditions prevailing during operation on the ground and/or in flight. In this way, the operation of a gas turbine assembly having a proposed nozzle device is significantly simplified and optimized, for example with a view to the control system/feedback control system.

In one preferred variant of configuration, the correlated portion is disposed at least within a nozzle bracket of the nozzle device. The nozzle bracket is in particular disposed between the supply line system and the nozzle main body (e.g. comprising the manifold assembly/assemblies).

Flow conditions which are mutually adapted in a particularly advantageous manner are achievable when the correlated portion extends across a majority of more than 50%, preferably more than 80%, of the length of the gas fuel line and of the liquid fuel line, with the exception of transition regions, for example. A transition region is formed in particular by a line portion in which the mutual disposal of the gas fuel line and of the liquid fuel line, and/or the configuration and/or the profile of at least (or only) one of the two fuel lines changes (e.g. in terms of the flow cross section and/or of the curvature).

The gas fuel line and/or the liquid fuel line at least in the correlated portion preferably have a circular circumference of the flow cross section AiH2, AiK. This is the case in a circular and/or annular flow cross section, for example.

In a variant of configuration optimized for installation space, the gas fuel line at least in the correlated portion is disposed so as to be in particular cylindrical and/or coaxial about the liquid fuel line. In this way, the gas fuel line is configured as an annular gap, or has an annular gap, which coaxially and preferably symmetrically surrounds the liquid fuel line.

Here, the following relationship applies to the correlation:

AiK=0.25×π×(DiK)² (circular area of the flow cross section of the liquid fuel line),

AiH2=0.25×π×(DiH2)²−0.25×π×(DiK+2×d)² (circular area of the flow cross section of the gas fuel line)

DiH2={square root over (4×(AiH2+0.25×π×(DiK+2×d)²)/π)}

where AiH2=F*AiK , where F=2.7 or 2.6 to 2.8.

Exemplary values are:

DiK=6 mm

AiK=28.27 mm²

AiH2=2.7*AiK=76.34 mm²

d=0.5 mm

DiH2=12.09 mm

Particularly favourable flow conditions are achieved with the correlation mentioned when the nozzle device is conceived for the (simultaneous and/or temporally offset) operation with hydrogen as the gaseous fuel and a kerosene-based and/or a kerosene-related fuel as the liquid fuel (e.g. Jet A-1, diesel or a synthetic substitute fuel (SAF—“sustainable aviation fuel”)), in particular in terms of the (other) flow cross sections, the selection of materials and/or sealing means, or the like.

Furthermore proposed in order for the object to be achieved is a set comprising at least one gas connector line and at least one liquid connector line for installation in a supply line system having a gas supply line system for guiding a gaseous fuel to at least one nozzle device, and having a liquid supply line system for guiding a liquid fuel to at least one nozzle device.

It is provided here that at least in portions, in at least one correlated portion, the gas connector line is configured so as to be correlated with the liquid connector line, wherein a flow cross section AiH2 of the gas connector line is proportional to a flow cross section AiK of the liquid connector line by a factor F, where:

AiH2=F*Aik, F being between 2.4 and 3, preferably between 2.6 and 2.8, e.g. 2.7.

The correlated portion relates in particular to a portion of the same type (for example having the same relative position, e.g. in terms of the length and/or an end of the respective connector lines) within the respective connector line.

The gas connector line and/or the liquid connector line are/is in particular of a flexible design and/or of identical length. In particular, there is exactly one gas connector line and exactly one liquid connector line per nozzle device. The gas connector line serves for fluidically connecting the gas fuel line to a gas ring line of a supply line system. The liquid connector line serves for fluidically connecting the liquid fuel line to a liquid ring line of a supply line system.

The gas supply line system comprises in particular one, e.g. exactly one, gas ring line and at least one gas connector line for the fluidic connection between the gas ring line and one of the nozzle devices.

The liquid supply line system comprises in particular one, e.g. exactly one, liquid ring line and at least one liquid connector line for the fluidic connection between the liquid ring line and one of the nozzle devices.

Moreover proposed in order to achieve the object is a set comprising at least one gas ring line, having a flow cross section which is in particular circular at least in portions, and at least one liquid ring line, having a flow cross section which is in particular circular at least in portions, for installation in a supply line system having a gas supply line system for guiding a gaseous fuel to at least one nozzle device, and having a liquid supply line system for guiding a liquid fuel to at least one nozzle device, wherein the nozzle device is configured in particular according to one of the preceding claims.

It is provided here that at least in portions, in at least one correlated portion, the gas ring line is configured so as to be correlated with the liquid ring line, wherein a flow cross section AiH2 of the gas ring line is proportional to a flow cross section AiK of the liquid ring line by a factor F, where:

AiH2=F*Aik, F being between 2.4 and 3, preferably between 2.6 and 2.8, e.g. 2.7.

In the case of respective circular flow cross sections, this results in the following correlation:

DiH2=1.643*DiK, where F=2.7, or

DiH2=1.612 to 1.673*DiK for F=2.6 to 2.8.

The ring lines are in particular disposed externally in an annular manner about a combustion chamber and serve for collectively directing the respective fuels to the nozzle devices. During operation, a partial quantity for operating the nozzle device is in each case retrieved from the ring line at a respective nozzle device, and supplied to the respective nozzle device in particular by means of the connector lines.

The correlated portion relates in particular to a portion of the same type (for example having the same relative position, e.g. in terms of the revolving direction and/or a line branch within the respective ring line) within the respective ring line.

Flow conditions which are mutually adapted in a particularly advantageous manner are achievable when the correlated portion extends across a majority of more than 50%, preferably more than 80%, of the length of the gas connector line and of the liquid connector line and/or of the gas ring line and of the liquid ring line, with the exception of transition regions, for example. A transition region is formed in particular by a line portion in which the mutual disposal of the ring lines and/or connectors lines, and/or the configuration and/or the profile of at least (or in particular only) one of the two ring lines or connector lines changes (e.g. in terms of the flow cross section and/or of the curvature).

Particularly favourable comparable flow conditions are achieved with the correlation mentioned when the gas connector line and the liquid connector line and/or the gas ring line and the liquid ring line are conceived for the operation with hydrogen as the gaseous fuel and a kerosene-based and/or a kerosene-related fuel as the liquid fuel (e.g. Jet A-1, diesel or a synthetic substitute fuel (SAF - “sustainable aviation fuel”)), in particular in terms of the (other) flow cross sections, the selection of materials and/or sealing means, or the like.

In terms of the supply line system the object is achieved by a supply line system comprising a gas supply line system for guiding a gaseous fuel to at least one nozzle device, and a liquid supply line system for guiding a liquid fuel to at least one nozzle device, wherein the nozzle device is configured in particular according to one of the preceding claims, having at least one set comprising a gas connector line and at least one liquid connector line according to one of the preceding variants of design embodiment, and/or having a set comprising at least one gas ring line and at least one liquid ring line according to one of the preceding variants of design embodiment.

In terms of the gas turbine assembly, in particular engine for an aircraft, the object is achieved by at least one nozzle device of one of the preceding variants of embodiment, and/or having at least one set and/or supply line system according to one of the preceding variants of embodiment.

The invention will be explained in more detail hereunder by means of exemplary embodiments with reference to the drawings, in which:

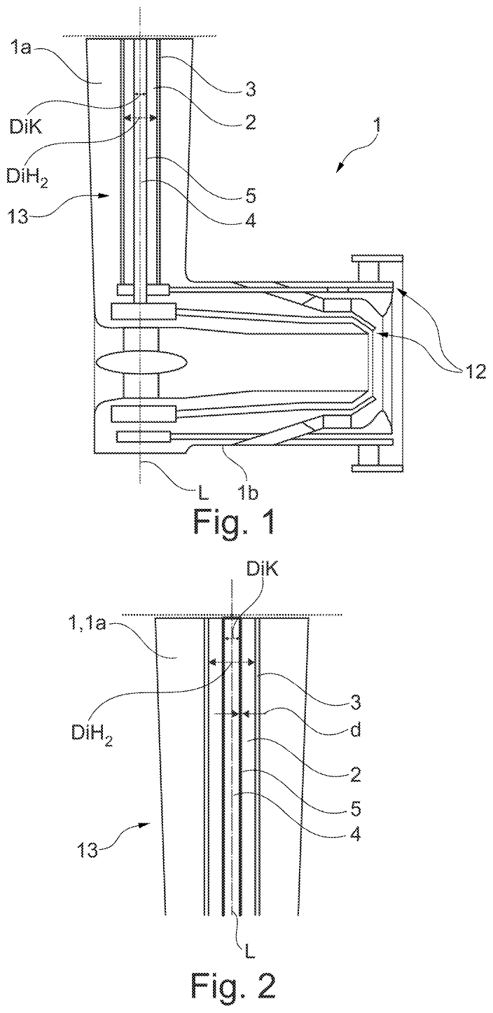

FIG. 1 shows a nozzle device having a nozzle bracket and a nozzle main body as well as a correlated portion of a gas fuel line and of a liquid fuel line in a longitudinal sectional view;

FIG. 2 shows an enlarged illustration of part of the nozzle bracket of the nozzle device according to FIG. 1 in the longitudinal sectional view; and

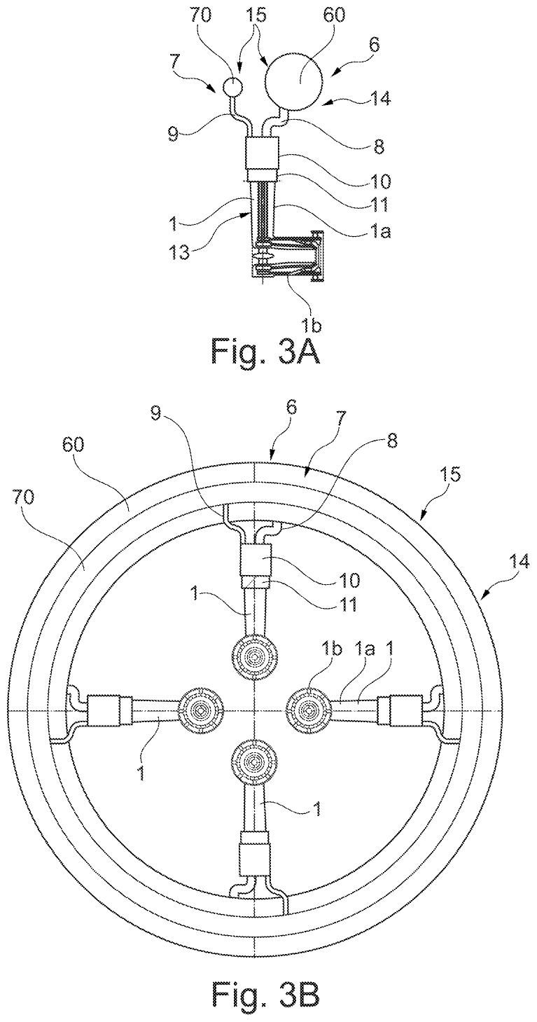

FIG. 3A, 3B show a supply line system having a gas ring line, a liquid ring line, a gas connector line, and a liquid connector line as well as one nozzle device (FIG. 3A) or four nozzle devices (FIG. 3B) in the longitudinal sectional view or in a frontal view when viewed from the direction of a combustion chamber.

FIG. 1 in a longitudinal sectional illustration shows a nozzle device 1 for alternatively and/or simultaneously feeding gaseous fuel and/or liquid fuel into a combustion chamber of a gas turbine assembly, in particular of the engine of an aircraft.

The nozzle device 1 is conceived for the operation with hydrogen as the gaseous fuel, and a kerosene-based and/or a kerosene-related fuel (e.g. Jet A-1, diesel, or a synthetic substitute fuel (SAF—“sustainable aviation fuel”)) as the liquid fuel. The fuels may be used alternatively or simultaneously.

The nozzle device 1 has a nozzle main body lb by way of which gaseous and/or liquid fuel is injected into the combustion chamber by means of nozzle openings 12 during operation. The nozzle openings 12 are in particular configured differently for gaseous fuel and liquid fuel.

Furthermore, the nozzle device 1 has a nozzle bracket la which is aligned along a longitudinal axis L. An enlarged illustration of part of the nozzle bracket 1 a is shown in FIG. 2.

Disposed within the nozzle bracket 1 a are a gas fuel line 2 for the fluidic connection between a gas supply line system 7 (cf. FIGS. 3A, B), and a liquid fuel line 4 for the fluidic connection between a liquid supply line system 6 (cf. FIGS. 3A, B), and the nozzle openings 12.

The gas fuel line 2 and the liquid fuel line 4 are configured to collectively direct the respective fuel (gaseous and liquid) for the operation of a respective nozzle device 1 to the nozzle main body 1b, by way of a respective manifold assembly (for gaseous and for liquid fuel). During operation, the respective fuels are directed to the corresponding nozzle openings 12 by means of the manifold assemblies.

The gas fuel line 2 and the liquid fuel line 4 are in particular configured so as to be cylindrical, having a circular circumference, and extend along the longitudinal axis L, being symmetrical to the latter. The gas fuel line 2 at least axially extends largely in a cylindrical manner about the liquid fuel line 4 and coaxially with the longitudinal axis L, while forming a symmetrical annular gap. A wall 5 of the liquid fuel line 4 has a wall thickness d. The gas fuel line 2 is delimited by a wall 3.

The liquid fuel line 4, lying inside, at least largely has a flow cross section having a circular diameter DiK (internal diameter of the wall 5). The gas fuel line 2, disposed cylindrically about the liquid fuel line 4, at least largely has an annular flow cross section having a circular diameter DiH2 (internal diameter of the wall 3).

For an optimized operation with gaseous fuels as well as liquid fuels, the gas fuel line 2 and the liquid fuel line 4 are conceived so as to mutually correlate in a correlated portion 4. A flow cross section AiH2 of the gas fuel line 2 here is proportional to a flow cross section AiK of the liquid fuel line by a factor F, where:

AiH2=F*AiK, F being between 2.4 and 3, preferably between 2.6 and 2.8, e.g. 2.7.

It has been demonstrated that, as a result of the basic design, similar flow properties can advantageously be achieved in the operation for hydrogen as the gaseous fuel and the kerosene-based, or kerosene-related fuel at typical operational conditions of an aircraft (in operation on the ground and/or in flight). This offers advantages, e.g. in terms of the control system and/or feedback control system of the engine.

The correlated portion 13 relates to the same axial position in terms of the gas fuel line 2 and of the liquid fuel line 4, i.e. the flow cross sections AiK, AiH2 or diameters DiK, DiH2 at a specific axial position, or in a specific axial portion, are mutually proportional by the factor F. The correlated portion 13 extends across a majority of more than 50%, preferably more than 80%, of the length of the gas fuel line 2 and of the liquid fuel line 4, for example with only the exception of transition regions in which the mutual disposal of the fuel lines 2, 4 and/or the profile of at least (or in particular only) one fuel line changes (e.g. in terms of the flow cross section and/or the curvature).

In the example shown in FIG. 1, the following correlation for the diameter DiH2 of the gas fuel line 2 is derived from the given diameter DiK of the liquid fuel line 4:

AiK=0.25×π×(DiK)² (circular area of the flow cross section of the liquid fuel line),

AiH2=0.25×π×(DiH2)²−0.25×π×(DiK+2×d)² (circular area of the flow cross section of the gas fuel line 2)

DiH2={square root over (4×(AiH2+0.25×π×(DiK+2×d)²)/π)}

where AiH2=F*AiK , where F=2.7 or 2.6 to 2.8.

Exemplary values are:

DiK=6 mm

AiK=28.27 mm²

AiH2=2.7*AiK=76.34 mm²

d=0.5 mm

DiH2=12.09 mm

FIG. 3A and FIG. 3B show a supply line system 14 and a nozzle device 1, which is disposed on the supply line system 14, in the cross section (FIG. 3A) as well as a frontal view (viewed from the direction of a combustion chamber) onto the supply line system 14, four nozzle devices 1 being disposed on the latter by way of example (FIG. 3B).

The supply line system 14 comprises a gas supply line system 6 for guiding the gaseous fuel to the nozzle devices 1. Furthermore, the supply line system 14 comprises a liquid supply line system 7 for guiding the liquid fuel to the nozzle devices 1. The nozzle devices 1 each have in particular the correlated portion 13.

The gas supply line system 6 comprises a gas ring line 60 and exactly one gas connector line 8 per nozzle device 1. The liquid supply line system 7 comprises a liquid ring line 70 and exactly one liquid connector line 9 per nozzle device 1.

The gas ring line 60 and the liquid ring line 70 are configured so as to be annular in order to be disposed on a combustion chamber so as to externally run radially about the latter (not shown in FIG. 3A and FIG. 3B). The gas ring line 60 has a circular flow cross section AiH2 having a diameter DiH2. The liquid ring line 70 has a circular flow cross section AiK having a diameter DiK

The gas connector line 8 and the liquid connector line 9 each are in particular of a flexible configuration. The gas connector line 8 in terms of its basic shape has a circular flow cross section AiH2 having a diameter DiH2. The liquid connector line 9 in terms of its basic shape has a circular flow cross section AiK having a diameter DiK

The nozzle devices 1 are in each case suitably connected to the supply line system 14 by way of connecting elements 10 and/or 11.

For an optimized operation with gaseous fuels as well as liquid fuels, the gas line portions and the liquid line portions in the supply line system 14 comprising the ring lines 60, 70 and the connector lines 8, 9 are conceived so as to mutually correlate in at least one correlated portion 15, wherein the flow cross section of the gas line portion AiH2 is in each case proportional to the flow cross section of the liquid line portion AiK by the factor F, where:

AiH2=F*Aik, F being between 2.4 and 3, preferably between 2.6 and 2.8, e.g. 2.7.

Consequently, the following applies to respective circular flow cross sections of the correlated gas line portions and liquid line portions:

DiH2=1.643*DiK, where F=2.7, or

DiH2=1.612 to 1.673*DiK for F=2.6 to 2.8.

The correlation relates in particular to line portions of identical function (“line portions of the same type”), for example between the ring lines 60, 70, and/or between the connector lines 8, 9, and/or respective flow cross sections of identical shape, e.g. circular flow cross sections.

The correlated portions 15 each occupy a majority of the line length, for instance an extent of more than 50%, preferably more than 80%, for example with the exception only of transition regions in which the mutual disposal of the line portions 2, 4 and/or the profile of at least (or only) one line portion of the same type changes (e.g. in terms of the flow cross section and/or the curvature).

In the operation of the engine with gaseous fuels or with liquid fuels, flow conditions of the same type are advantageously obtained across the majority of the line profile of the supplying line system 14 and of the nozzle device 1 in particular when the nozzle devices 1 are also configured with the correlated portions 13, as a result of which the operation can be optimized in particular with a view to the control system and/or feedback control system.

### List of Reference Signs

1 Nozzle device
1a Nozzle bracket
1b Nozzle main body
2 Gas fuel line
3 Wall
4 Liquid fuel line
5 Wall
6 Gas supply line system
60 Gas ring line
7 Liquid supply line system
70 Liquid ring line
8 Gas connector line
9 Liquid connector line
10 Connecting means
11 Connecting means
12 Nozzle opening
13 Correlated portion
14 Supply line system
15 Correlated portion
DiH2 Diameter
DiK Diameter
d Wall thickness
L Longitudinal axis

1. A nozzle device for feeding at least one gaseous fuel and one liquid fuel into a combustion chamber of a gas turbine assembly, in particular an engine of an aircraft, comprising
a nozzle main body having nozzle openings for injecting the gaseous fuel and/or the liquid fuel into the combustion chamber, and
at least one liquid fuel line for the fluidic connection between a liquid supply line system and the nozzle openings, and at least one gas fuel line for the fluidic connection between a gas supply line system and the nozzle openings,
characterized in that
at least in portions, in at least one correlated portion, the gas fuel line is configured so as to be correlated with the liquid fuel line, wherein a flow cross section AiH2 of the gas fuel line is proportional to a flow cross section AiK of the gas fuel line by a factor F, where:
AiH2=F*Aik, F being between 2.4 and 3, preferably between 2.6 and 2.8, e.g. 2.7.

2. The nozzle device according to claim 1,
wherein the correlated portion is disposed at least within a bracket holder of the nozzle device.

3. The nozzle device according to claim 1,
wherein the correlated portion extends across a majority of more than 50%, preferably more than 80%, of the length of the gas fuel line and of the liquid fuel line, with the exception of transition regions, for example.

4. The nozzle device according to claim 1,
wherein
the gas fuel line and/or the liquid fuel line at least in the correlated portion have a circular circumference of the flow cross section AiH2, AiK.

5. The nozzle device according to claim 1,
wherein
the gas fuel line at least in the correlated portion is disposed so as to be in particular cylindrical and/or coaxial about the liquid fuel line.

6. The nozzle device according to claim 1,
wherein
the nozzle device is conceived for the operation with hydrogen as the gaseous fuel and a kerosene-based and/or kerosene-related fuel as the liquid fuel.

7. A set comprising at least one gas connector line and at least one liquid connector line for installation in a supply line system having a gas supply line system for guiding a gaseous fuel to at least one nozzle device, and having a liquid supply line system for guiding a liquid fuel to at least one nozzle device, wherein the nozzle device is configured according to claim 1,
wherein
at least in portions, in at least one correlated portion, the gas connector line is configured so as to be correlated with the liquid connector line, wherein a flow cross section AiH2 of the gas connector line is proportional to a flow cross section AiK of the liquid connector line by a factor F, where:
AiH2=F*Aik, F being between 2.4 and 3, preferably between 2.6 and 2.8, e.g. 2.7.

8. The set comprising at least one gas ring line, having a flow cross section which is in particular circular at least in portions, and at least one liquid ring line, having a flow cross section which is in particular circular at least in portions, for installation in a supply line system having a gas supply line system for guiding a gaseous fuel to at least one nozzle device, and having a liquid supply line system for guiding a liquid fuel to at least one nozzle device, wherein the nozzle device is configured according to claim 1,
wherein
at least in portions, in at least one correlated portion, the gas ring line is configured so as to be correlated with the liquid ring line, wherein a flow cross section AiH2 of the gas ring line is proportional to a flow cross section AiK of the liquid ring line by a factor F, where:
AiH2=F*Aik, F being between 2.4 and 3, preferably between 2.6 and 2.8, e.g. 2.7.

9. The set according to claim 7,
wherein
the correlated portion extends across a majority of more than 50%, preferably more than 80%, of the length
of the gas connector line and of the liquid connector line and/or
of the gas ring line and of the liquid ring line,
with the exception of transition regions, for example.

10. The set according to claim 7,
wherein
the gas connector line and the liquid connector line and/or
the gas ring line and the liquid ring line
are conceived for the operation with hydrogen as the gaseous fuel and a kerosene-based and/or kerosene-related fuel as the liquid fuel.

11. A supply line system having a gas supply line system for guiding a gaseous fuel to at least one nozzle device, and having a liquid supply line system for guiding a liquid fuel to at least one nozzle device, wherein the nozzle device is configured in particular according to one of the preceding claims,
having at least one set comprising at least one gas connector line and at least one liquid connector line according to claim 7.

12. Gas turbine assembly, in particular engine for an aircraft, having at least one nozzle device according to one of claim 1.
